(19) United States
(12) Patent Application Publication
(10) Pub. No.: US 2003/0214190 A1
(43) Pub. Date: Nov. 20, 2003

(54) Connection device for hairpin wound electric machines

(75) Inventors: Christopher L. Congdon, Fishers, IN (US); Wei Cai, Carmel, IN (US); William Haworth, Pendleton, IN (US)

Correspondence Address: RUSSELL E. FOWLER, II, ICE MILLER, ONE AMERICAN SQUARE, BOX 82001, INDIANAPOLIS, IN, 46282-0002, US

(73) Assignee: Delco Remy America, Anderson, IN

(21) Appl. No.: 10/437,200

(22) Filed: May 13, 2003

Related U.S. Application Data
(60) Provisional application No. 60/380,643, filed on May 15, 2002.

(51) Int. Cl. H02K 11/00

(52) U.S. Cl. 310/71

(57) ABSTRACT

A connection device reduces the amount of labor required to make the final connections of the winding schematic by using a part that only needs to be placed on top of the stator and soldered, welded, crimped or hotstaked/coldstaked in place. The connection device comprises an insulative plate having a plurality of slots positioned therein. Each of the plurality of slots are arranged and disposed on the plate to align with and to receive a conductor leg end from the winding head of a stator. A plurality of pins are positioned on the plate, each of the plurality of pins adjacent to one of the plurality of slots and extending from the plate. A plurality of jumpers are embedded in the plate, each of the plurality of jumpers extending between the pins and providing a conductive path between the slots in the plate.

### CROSS-REFERENCE TO RELATED APPLICATIONS

This application claims the benefit of U.S. Provisional Application No. 60/380,643 filed May 15, 2002.

### BACKGROUND

1. Field

This invention addresses the field of manufacture and assembly of armatures for electric machines and particularly hairpin wound armatures for mid- to small-sized electric machines.

2. Discussion

Hairpin wound stators are known in the art. FIG. 1 shows an exemplary perspective view of a hairpin wound stator. The stator includes a stator core 12 having a number of conductors or “hairpins” 14 inserted into the slots of the stator core. As shown in FIG. 2, a hairpin is a segment of wire that is used to form part of a winding. The wire segment is bent into a “U” shape to form two legs 16 and an end-turn 18 on the “hairpin.” The wire segment typically has a rectangular cross-section. The legs of the hairpins are inserted into the slots of the stator with each leg of the hairpin in a different stator slot such that the end-turn of the hairpin extends over several stator slots (e.g., each hairpin may extend three stator slots). Each hairpin inserted into a stator slot is staggered or “interleaved” with respect to adjacent hairpins. When a hairpin is fully inserted into the slots of the stator, the end turn 18 will extend from one end of the stator, and the legs will extend from the opposite end 19 of the stator. Any given stator slot will include a number of hairpin legs (e.g., 4), and each hairpin leg is referred to as a layer within the stator slot. Insulation 15 is included on the portion of each leg situated within a stator slot to prevent electrical connection between the legs in different layers of the same stator slot.

Once all hairpins are inserted into the slots of the stator, the ends of the legs extending from the end 17 of the stator are bent. To reduce winding height, the legs on alternating layers are bent in opposite directions (e.g., the legs on layer one are bent counter-clockwise in the same direction and the legs on layer two are bent in the opposite direction, clockwise). The number of stator slots that each leg is bent is determined upon the design of the electric machine (e.g., each leg may be bent three slots so that the hairpin extends a total of twelve slots from end-to-end if the end turn extends six slots). FIG. 3 shows a close-up view of a typical arrangement of the hairpin legs once the legs are inserted into the slots of a stator and bent the desired amount. As shown in FIG. 3, the legs are bent such that each leg terminates adjacent to another leg. This allows an electrical connection be easily established between each hairpin leg. In particular, once all hairpin legs are inserted into the stator and bent, an automated connection device can be used to weld legs together. For example, adjacent legs 21 and 22 may be welded together and adjacent legs 23 and 24 may be welded together. Similar welds would be made for other adjacent legs around the stator. The automatic connection device may also provide insulation that covers the ends of the legs to prevent electrical shorts between two nearby legs that are not intended to be connected. The term “adjacent leg ends” is used herein to refer to two hairpin leg ends from different hairpins that are immediately adjacent to one another (such as leg ends 21 and 22 and 23 and 24 of FIG. 3) when the legs are bent into the proper arrangement in the stator core. Non-adjacent leg ends are any leg ends that are not adjacent leg ends (e.g., leg ends diagonally opposed to each other such as leg ends 21 and 26 of FIG. 3, and leg ends removed by several positions such as leg ends 21 and 27 of FIG. 3). This portion of the stator winding extending above the stator core forms the winding head 28. The term “coil end” is also used herein to refer to the end of a conductor that requires connection to another conductor in order to form a completed winding.

An exemplary hairpin winding arrangement that may be used for a typical sixty slot stator is shown in FIGS. 4-6. FIG. 4 shows an exemplary winding arrangement for phase A. FIG. 5 shows an exemplary winding arrangement for phase B. FIG. 6 shows an exemplary winding arrangement for phase C. The A, B, and C phase windings are connected in a typical Y-connection. As shown in FIGS. 4-6, a series of special winding connections are involved with the hairpins found in stator slots 54-60 and 1-6. In particular, terminal connections, ground connections, jumper connections, and different non-standard slot-pitch lengths must be made for the hairpins in these stator slots. All other hairpins are simply joined to an adjacent hairpin (i.e., the ends of the legs from layer 1 are connected to the ends of adjacent legs from layer 2 and the ends of the legs from layer 3 are connected to the ends of adjacent legs from layer 4).

While connection of adjacent leg ends is easily accomplished with an automatic connection machine, the special non-standard winding connections described above are difficult to accomplish as they require tedious manual connection using jumpers from one leg end to another non-adjacent leg end. This labor intensive process when making the connections to match the winding schematic increases manufacturing costs for the electric machine.

FIG. 7 shows an example of the required non-standard connections for the winding schematic of FIGS. 4-6. The required jumper and terminal connections shown in FIGS. 4-6 (e.g., F_{B4}, S_{A2}, etc.) are also noted. FIG. 7 shows a top view of adjacent leg ends for the hairpins inserted into stator slots 53 to 7 for layers 1 and 3 and the hairpins inserted into stator slots 59 to 13 for layers 2 and 4. Each box in FIG. 7 represents a leg end, and the number in the box represents the stator slot number where the leg is inserted in the stator. Note that the adjacent leg ends are offset by six slots because layers 1 and 3 were bent three slots counterclockwise and layers 2 and 4 were bent three slots clockwise. To complete the winding connections for these slots as shown in the winding schematic of FIGS. 4-6, the connections indicated by solid lines between the leg ends will need to be made. While some of these connections could be easily made because they are adjacent leg ends (e.g., leg ends 1 and 55 in layers 2 and 3), many other connections are difficult to make because they are not adjacent leg ends (e.g., leg ends 7 and 2 in layers 4 and 3). These leg ends require labor intensive manual connections that take a good deal of time and significantly increase manufacturing costs. Accordingly it would be advantageous to provide a fast, efficient, and simple apparatus and related method for electrically connecting the non-standard connections required with hairpin wound stators.

### SUMMARY

As discussed above, the present technology of “winding” stators involves forming “U-shaped” or “hairpin” shaped conductors, nesting the hairpins, inserting the hairpins into the stator core, and twisting the leg ends of the hairpins to the desired pitch or span to set up connections for the coil windings. To complete the winding of the stator, the leg ends of the hairpins (i.e., the “coil ends”) are connected to each other in order to match the desired winding schematic. Unfortunately, not all connections are made with the same pitch or span. For example, when manufacturing stators according to a certain winding schematic with a six-slot pitch/span, the hairpin legs are twisted three slots clockwise and three slots counter-clockwise, giving an overall pitch/span of six. Nevertheless, to match the winding schematic some of the hairpins still need to be connected as a five-slot pitch/span. Using current technology, wires are pulled out of the top of the winding, or winding head, are bent into place and bonded by various means (soldering, welding, or crimping). This can lead to a very complicated and labor-intensive process.

A connection device reduces the amount of labor required to make the final connections of the winding schematic by using a part that only needs to be placed on top of the stator and soldered, welded, crimped or hotstaked/coldstaked in place. The connection device comprises an arcuate plate comprised of an insulative material, the plate having a plurality of slots/windows positioned therein. Each of the plurality of slots in the plate are arranged and disposed on the plate to align with and to receive a leg end of one of the plurality of hairpins extending from the winding head of a stator. A plurality of pins are positioned on the plate, each of the plurality of pins adjacent to one of the plurality of slots and extending from the plate. A plurality of conductive jumpers are embedded in the plate, each of the plurality of jumpers extending between the pins. Because each of the pins is associated with one of the plurality of slots in the plate, the jumpers are capable of providing an electrical connection between the slots in the plate. A plurality of recesses are also formed along the edges of the plate. When the connection device is placed on the winding head of a stator, the hairpin leg ends extend through the slots of the plate and extend from the plate adjacent to the pins of the plate. Connection of the hairpin leg ends and their associated pins provides for proper connection between each of the hairpin windings and completes the windings upon the stator.

The connection device may further comprise a side arm that includes an insulative housing and at least one side jumper embedded therein. The at least one side jumper includes two jumper ends and each of the jumper ends extends from the housing. The side jumper is designed to connect to the plate such that each of the jumper ends fit into one of the plurality of slots in the plate.

The use of the connection device gives the stator a more uniform appearance and reduces the opportunity for operator error in connecting the wrong hairpin legs together or placing the connection in the wrong position. In addition, the connection device allows for the use of an automated system for joining the connection device to the winding head during the final connection stage of stator assembly.

### BRIEF DESCRIPTION OF THE DRAWINGS

FIG. 1 shows a perspective view of a hairpin wound stator before the connections are made;

FIG. 2 shows a perspective view of a hairpin for insertion into the slot of a hairpin wound stator before the hairpin is bent;

FIG. 3 shows an enlarged view of a portion of a stator and hairpins inserted into the slots of a stator before electrical connections are established between the hairpins;

FIG. 4 shows a winding schematic for phase A of a typical three-phase alternator winding;

FIG. 5 shows a winding schematic for phase B of a typical three-phase alternator winding;

FIG. 6 shows a winding schematic for phase C of a typical three-phase alternator winding;

FIG. 7 shows a top view of the required non-standard connections for the winding schematic of FIGS. 4-6;

FIG. 8 shows a top view of a connection device or “crown” according the present invention;

FIG. 9 shows a jumper insert for the connection device of FIG. 8; hairpin stator assembly;

FIG. 10 shows a side component for the connection device of FIG. 8;

FIG. 11 shows a jumper insert for the side component of FIG. 10;

FIG. 12 shows a perspective view of a hairpin wound stator before the connection device and side component are inserted onto the stator;

FIG. 13 shows a perspective view of the hairpin wound stator after the connection device and side component are inserted onto the stator;

FIG. 14 shows a side view of the hairpin wound stator with connection device and side component of FIG. 13;

FIG. 15 shows a top view of an alternative embodiment of a connection device;

FIG. 16 shows a perspective view of the connection device of FIG. 15; and

FIG. 17 shows the connection device of FIG. 15 inserted onto a hairpin wound stator.

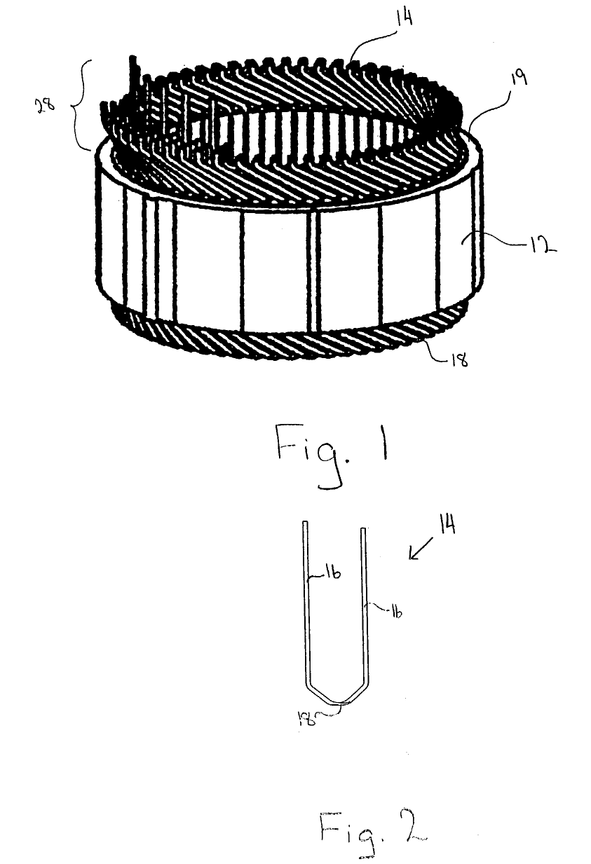

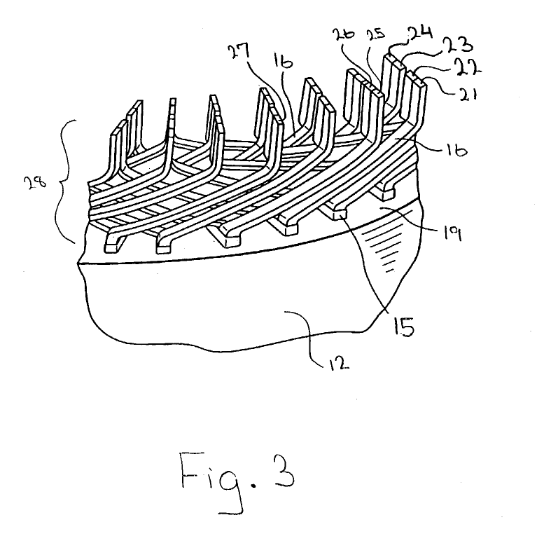

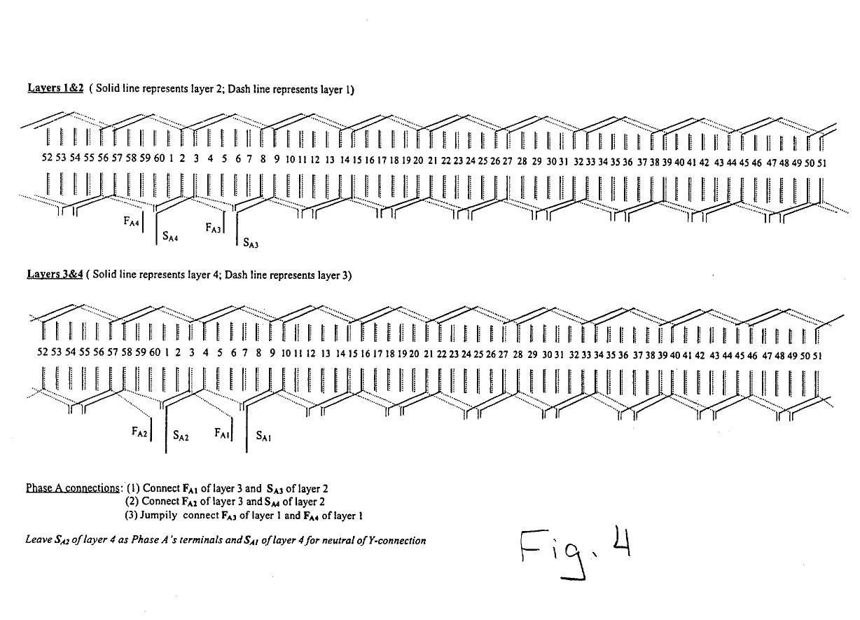

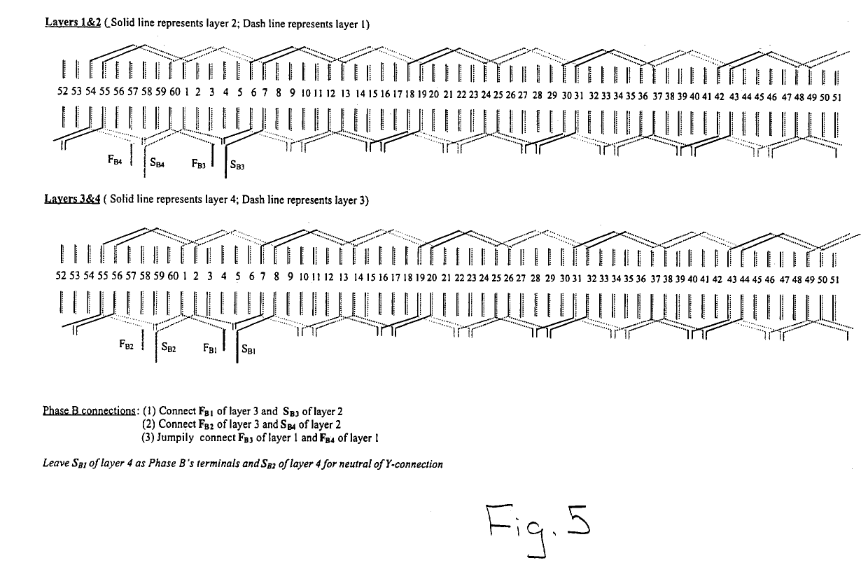

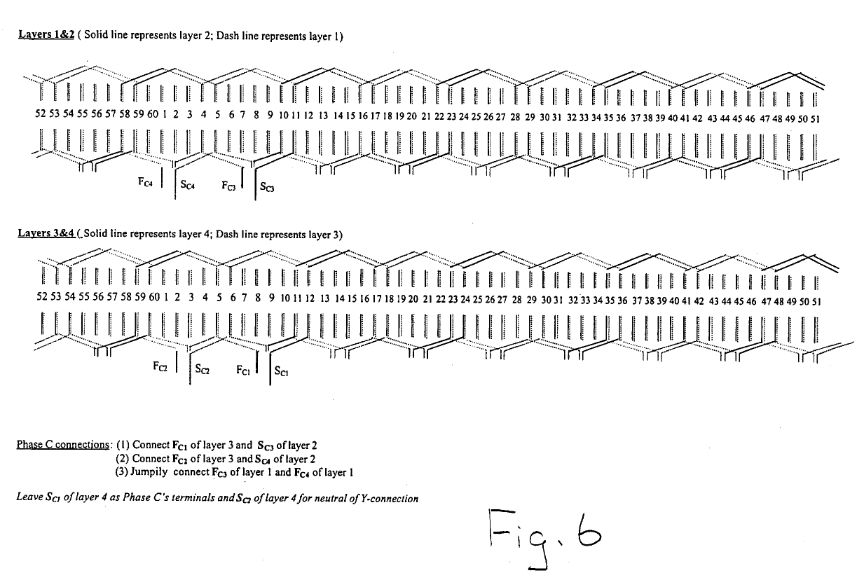

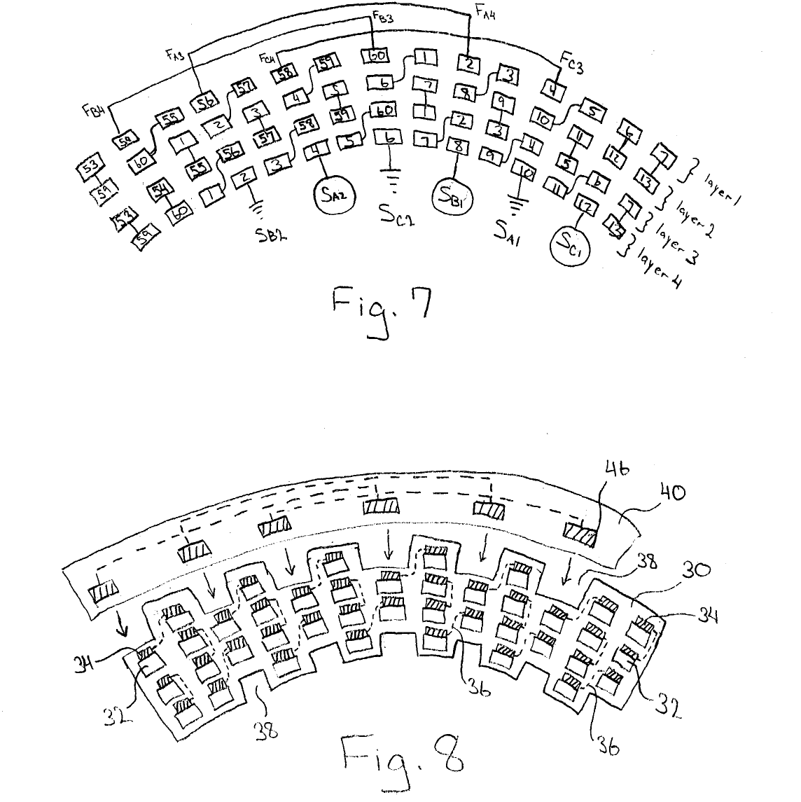

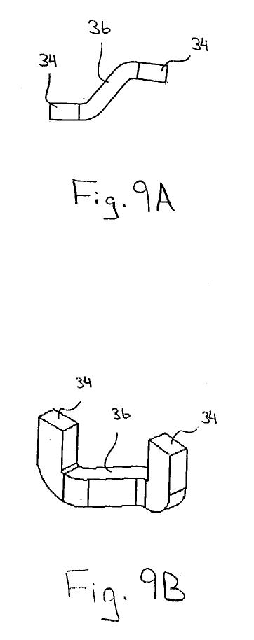

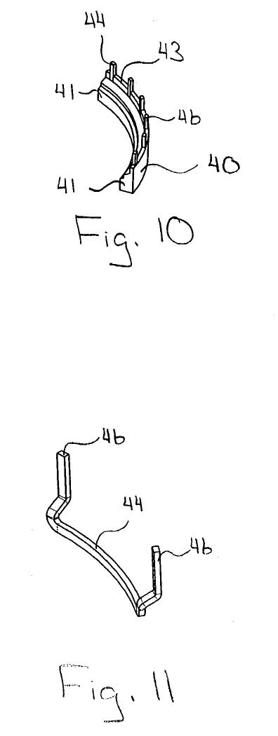

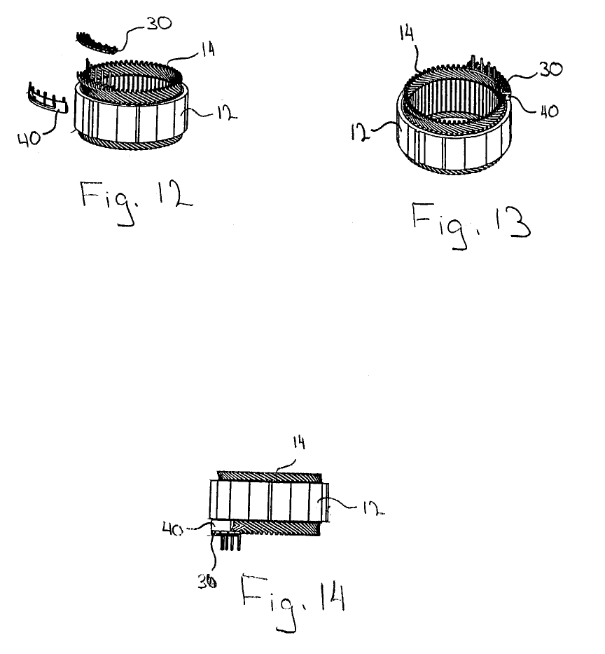

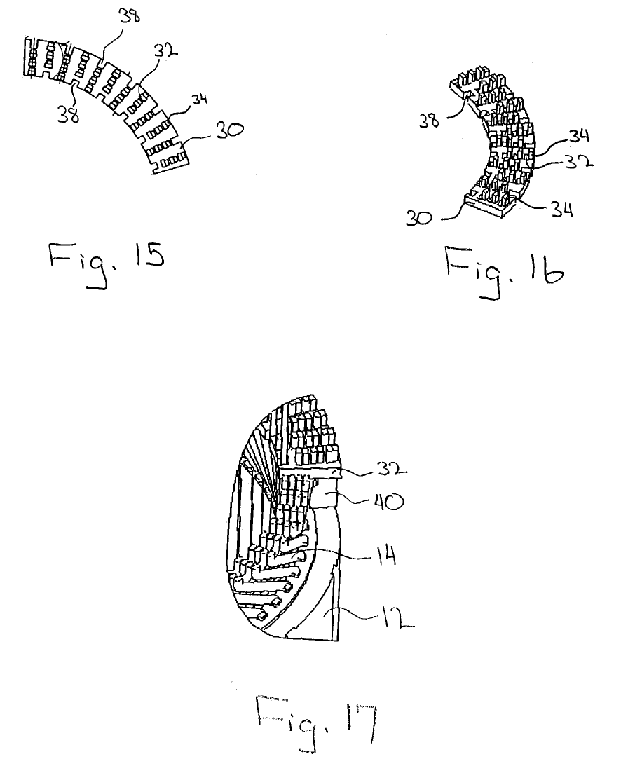

### DESCRIPTION

With reference to FIG. 8, a top view of a connection device for use with a stator is shown. The connection device includes a plate 30 made of a high temperature insulative material such as a thermoplastic material or other non-conductive material. The plate 30 is arcuate in shape and includes a plurality of connection slots 32 (which may also be referred to herein as “windows”, “holes”, “crown slots”, “plate slots” or “slots”) that form passages in the plate. The connection slots 32 are positioned upon the plate 30 such that each connection slot may be aligned with and receive one hairpin leg end of the stator. In addition, a plurality of recesses 38 are formed along the sides of the plate. The recesses provide additional plate pass-through locations for hairpin leg ends. The hairpin leg ends passing through the recesses are typically used for terminal connections, ground connections, and/or additional jumper connections.

A plurality of pins 34 are positioned upon the plate 30 with each pin positioned adjacent to and associated with one of the plate slots 32. The pins 34 are made of copper or other conductive material. Each of the pins 34 include one end that is embedded in the plate 30 and an opposite end that extends above-the surface of the plate.

A plurality of jumpers 36 are embedded in the plate. Although the jumpers are not visible since they are embedded in the plate, the connections made by the jumpers are indicated in FIG. 8 by dotted lines. Each jumper 36 connects the embedded ends of two pins 34 to provide a conductive path between the two pins. All of the jumpers in the plate are typically located in the same vertical plane to keep the profile of the plate as low as possible. As shown in FIG. 8, the jumpers may be located in different radii from the center and may take a number of different forms, including straight jumpers and/or C-shaped jumpers that connect adjacent pins (i.e., those pins directly opposed to the pin, but not diagonal from the pin) and curved jumpers such as Z-shaped or S-shaped jumpers that connect non-adjacent pins (such as diagonally opposed pins). The Z-shaped and S-shaped jumpers are used to connect non-adjacent pins, such as pins in different slot rows and different layers. The jumpers 36 may or may not be integral with the pins 34 that they connect. For example, a jumper and integral pin is shown in FIGS. 9A and 9B. The jumper 36 is the curved portion that joins the two short pins 34. As best seen in FIG. 9A, the jumper is S-shaped and designed to connect to non-adjacent pins on the plate. Of course, the jumpers are not limited to the embodiments shown and described and may take any number of different forms.

In one embodiment of the invention the connection device 20 includes a side arm 40 as shown in FIG. 10. The side arm 40 is comprised of a housing 42 made of insulative material, such as a thermoplastic material. The housing has a thicker base 41 that is contoured up to a thinner top sidewall 43. A plurality of side jumpers 44 (see FIG. 11) are embedded in the housing 42. The side jumpers 44 are made of a conductive material such as copper. Each side jumper 44 includes two jumper ends 46 that extend from the housing 42 through the top sidewall 43. The side jumpers 44 embedded in the housing 42 are relatively long and are used to connect two nonadjacent leg ends that are removed from each other by one or more rows of other leg ends. For example, as shown in FIG. 8, the side jumpers are used to provide the connections for F_{A3} and F_{A4}, F_{B3} and F_{B4}, and F_{C3} and F_{C4}. The jumper ends that extend from the housing are designed to extend through the recesses on the outer diameter of the plate such that the jumper ends may be easily connected to hairpin leg ends also extending through the recesses.

The connection device is positioned upon a stator to complete connections between a group of hairpin leg ends. For example, the connection device shown in FIG. 8 may be used to provide the connections between hairpin leg ends shown in FIG. 7. In particular, the connection device is used to complete non-standard connections commonly required with hairpin stator windings. To this end, the connection device is positioned upon the stator such that a group of leg ends extend through the slots of the stator. Preferably, as shown in FIG. 12 the leg ends to be connected using the connection device are somewhat longer and extend slightly above the other leg ends of the stator. This allows the connection device to be easily inserted on to the extended leg ends. When the connection device is inserted on to the extended leg ends, the leg ends will pass through each of the slots of the plate and extend above the slots of the plate. Thereafter, connection may be easily made between each leg end and each pin associated with the leg end (i.e., the leg end that extends through the plate slot associated with the pin). This connection may be a weld, solder, crimp, hotstake/coldstake or any other connection method sufficient to complete a winding in a hairpin wound electric machine. With the connections between the pins and the leg ends properly made, the windings for the non-standard windings for the hairpin wound electric machine are easily completed.

During assembly, the connection device provides a method for making non-standard connections for a hairpin wound stator. With reference to FIGS. 12-14, a stator is provided having a stator core 12 and a plurality of stator slots formed in the stator core. As described previously, hairpins are inserted into the slots of the stator with the legs of the hairpins forming different layers in each stator slot. On one side of the stator, the hairpins form end turns and on the opposite side of the stator the legs of the hairpins extend from the stator slots. Thereafter, the legs of the hairpins are bent to form a desired winding configuration. Legs in alternate layers are typically bent in opposite directions. After the legs are bent, groups of adjacent leg ends are formed. An automatic connection device is then used to connect adjacent leg ends except for those adjacent leg ends requiring special non-standard connections.

The connection device or “crown” is then inserted on winding head, and particularly the windows of the connection device are inserted on the hairpin leg ends requiring special connections. This may require a portion of the winding head to be expanded in a radial direction to line up with the windows in the connection device. Such an expanded portion of the winding head is shown in FIG. 12. The bottom edges of the windows of the connection device may be beveled to aid in alignment and positioning of the crown on the hairpin leg ends. When the connection device is inserted onto the leg ends on this portion of the winding head, the hairpin leg ends will project through the windows of the connection device. Because each window has an associated pin that extends from the plate, each hairpin leg end extending through a window will be adjacent to a pin. By connecting the hairpin leg ends to their associated pins, the special connections for the winding are made and the winding is completed. The connections between the hairpin legs and the associated pins may be made by any number of different methods known in the art including soldering, welding, crimping or hotstaking/coldstaking the connections.

If the side arm is used for additional jumper connections, the side arm is simply inserted under the plate with the jumper ends 46 positioned in the recesses of the plate and the base 41 of the side arm 40 abutting the stator core. The jumper ends may then be connected to the hairpin leg ends extending through the recesses. Connection of the jumper ends to the leg ends completes any remaining jumper connections and attaches the side arm to the plate. Alternatively, the plate and side arm may include a snap-fit connection that secures the side arm to the plate. FIG. 12 shows a perspective view of the side arm in relation to the stator before the side arm is connected to the plate of the connection device. FIG. 14 shows a side view of the stator with the connection device, including side arm, connected to the stator windings.

As stated above, the connection device shown in FIG. 8 is specifically designed for use with the winding schematic of FIGS. 4-6, and this is only one of many possible embodiments of the connection device. An alternative embodiment of the connection device is shown in FIGS. 15-17. This connection device is designed for use with a different winding configuration than that shown in FIGS. 4-6. With reference to FIG. 15, a top view of an alternative embodiment of the connection device is shown. The connection device includes a plate 30, having a plurality of windows 32 and associated pins 34. A plurality of jumpers 36 are embedded in the plate 30. In addition, the plate 30 includes a number of recesses 38 formed in the edges of the plate. When the connection device is positioned on top of the winding head, hairpin leg ends will project through the windows 32 and recesses 38 of the plate. The pins associated with each window are connected to the hairpin leg end that extends through the window. A perspective view of the connection device before it is joined to the winding head is shown in FIG. 16. A perspective view of the connection device joined to the winding head is shown in FIG. 17. As shown in FIG. 17, a side arm 40 may be used in association with the plate to provide certain jumper connections. Again, the embodiment of the connection device shown in FIGS. 15-17 is only one of many possible connection devices that may be designed, depending upon the winding schematic of the stator.

Although the connection device has been described as a single piece, in an alternative embodiment, the device can be broken into separate pieces in layers or pie shapes. Breaking the connection device into separate pieces will simplify the assembly/molding of the connection device. Interlocking details between the separate pieces can then be added to each component if desired. By segmenting the connection device the mass and added vibration that may be associated with a single crown can also be reduced.

In one embodiment of the invention, the connection device will not overhang the inner diameter of the stator lamination. However, it is possible to produce an embodiment where the connection device overhangs the inner diameter of the stator lamination. In this situation, the designer of the connection device and the party manufacturing the stator must be sure to discuss the assembly of the complete electrical machine to avoid damage to parts during assembly. To avoid damage to an overhanging connection device, the completed stator should be placed in the motor housing so the rotor can still be positioned in the stator. For example, if the connection device is on end A and of the stator and the rotor enters from end B, then it is possible for the connection device to overhang the stator lamination without damage during assembly.

Although the connection device has been described herein with respect to certain embodiments, other versions are possible. For example, although certain configurations for hairpin wound electric machines have been used herein in association with the connection device, the connection device is applicable to any and all configurations of hairpin wound electrical machines where coil ends need to be connected. Also, the connection device could be used with wire wound stators that do not use hairpins, but have coil ends that need to be connected. In addition, although the term “plate” has been used herein to describe the insulative device that forms the windows that accept leg ends, the term “plate” is not necessarily limited to a relatively flat device with uniform thickness. For example, the “plate” could be closer to a block shape or numerous other shapes. Furthermore, although the terms “slots” and “windows” have been described herein to refer to cavities that extend all the way through the plate, the slots/windows could be mere indentations in the plate designed to receive the hairpin leg ends, without the slots/windows extending all the way through the plate. Accordingly, the spirit and scope of the appended claims should not be limited to the description of the preferred versions contained herein.

What is claimed is:

1. A connection device for use with stators having a plurality of conductors used to form windings on the stator, the connection device comprising:
a. a plate comprised of an insulative material, the plate having a plurality of slots positioned therein, each of the plurality of slots arranged and disposed to receive a coil end of one of the plurality of conductors; and
b. a plurality of jumpers embedded in the plate, each of the plurality of jumpers capable of providing an electrical connection from one of the plurality of slots to another of the plurality of slots.

2. The connection device of claim 1 wherein the plate is made of a high temperature thermoplastic material.

3. The connection device of claim 1 wherein the plate is arcuate.

4. The connection device of claim 1 further comprising a plurality of pins, each of the plurality of pins adjacent to one of the plurality of slots and extending from the plate, and each of the plurality of jumpers connecting one of the plurality of pins to another of the plurality of pins.

5. The connection device of claim 1 wherein some of the plurality of slots are recesses formed along the edges of the plate.

6. The connection device of claim 1 further comprising a side arm, the side arm including an insulative housing and at least one side jumper embedded therein, the at least one side jumper including two jumper ends and each of the jumper ends extending from the housing and designed to fit into two of the plurality of slots in the plate.

7. The connection device of claim 1 wherein the slots include adjacent slots and non-adjacent slots, and at least one of the plurality of jumpers is capable of providing an electrical connection between non-adjacent slots.

8. A stator for use in an electromechanical device, the stator comprising
a. a core having a plurality of stator slots;
b. a plurality of conductors inserted into the stator slots and bent to a desired configuration, each of the plurality of conductors having two leg ends extending from the stator slots, the conductor leg ends forming adjacent conductor leg ends and non-adjacent conductor leg ends;
c. a connection device attached to a plurality of the leg ends extending from the stator core, the connection device including
(i) a plate;
(ii) a plurality of plate slots positioned upon the plate, the plurality of plate slots receiving conductor leg ends; and
(iii) a plurality of jumpers, each of the plurality of jumpers providing an electrical connection between at least two of the conductor leg ends positioned in the plurality of plate slots.

9. The stator of claim 8 wherein the plate is made of a high temperature thermoplastic material.

10. The stator of claim 8 wherein the stator is circular and the plate is arcuate.

11. The stator of claim 8 wherein the connection device further comprises a plurality of pins extending from the plate, each of the plurality of pins adjacent to one of the plurality of plate slots and connected to one of the conductor leg ends, and each of the plurality of jumpers connecting one of the plurality of pins to another of the plurality of pins.

12. The stator of claim 8 wherein some of the plurality of plate slots on the connection device are recesses formed along the edges of the plate.

13. The stator of claim 8 wherein the connection device further comprises a side arm, the side arm including an insulative housing and at least one side jumper embedded therein, the at least one side jumper including two jumper ends and each of the jumper ends connected to one of the conductor leg ends.

14. The stator of claim 8 wherein at least one of the plurality of jumpers provides an electrical connection between two non-adjacent conductor leg ends.

15. A method of forming windings upon a stator, the method comprising:
a. providing a stator core including a plurality of stator slots;
b. inserting a plurality of conductors into the stator slots, the plurality of conductors including leg ends that form adjacent leg ends and nonadjacent leg ends when inserted into the stator core;
c. providing a connection device having a plurality of connection slots and a plurality of jumpers, each of the plurality of jumpers providing an electrical connection between two of the plurality of the connection slots; and
d. inserting the connection device onto the stator core such that a plurality of the leg ends are inserted into a plurality of the connection slots.

16. The method of claim 15 wherein the connection device further includes a plurality of pins, each of the plurality of pins associated with one of the plurality of connection slots and each of the plurality of jumpers providing an electrical connection between two of the plurality of pins.

17. The method of claim 16 further comprising the step of connecting each of the plurality of pins to the leg end positioned in the connection slot associated with the pin.

18. The method of claim 15 further comprising the step of connecting a first plurality of adjacent leg ends without the use of the connection device.

19. The method of claim 18 wherein a first plurality of non-adjacent leg ends are connected using the connection device.
